(19) United States
(12) Patent Application Publication
(10) Pub. No.: US 2004/0008835 A1
(43) Pub. Date: Jan. 15, 2004

(54) Carrier selection system

(76) Inventors: Bruce R. Knox, Kirtland Hills, OH (US); Ronald L. Hutchinson, Longview, TX (US)

Correspondence Address: Renner, Kenner, Greive, Bobak, Taylor & Weber, 400 First National Tower, Akron, OH, 44308-1456, US

(21) Appl. No.: 10/192,018

(22) Filed: Jul. 10, 2002

(51) Int. Cl. H04M 7/00

(52) U.S. Cl. 379/221.02; 379/220.01

(57) ABSTRACT

A telephone carrier selection system allows for ease of effective interconnection between various customer telephone lines, local carrier lines, and long distance lines. A controller interconnects with relay switches to automatically select long distance lines when a first number dialed by a user is a “1” or “01,” indicating that a long distance number is to be dialed. The automatic switching feature of the invention can be overridden by an operator on a call-by-call basis by causing the first digit to be dialed a digit that indicates the selection of a specific carrier provider.

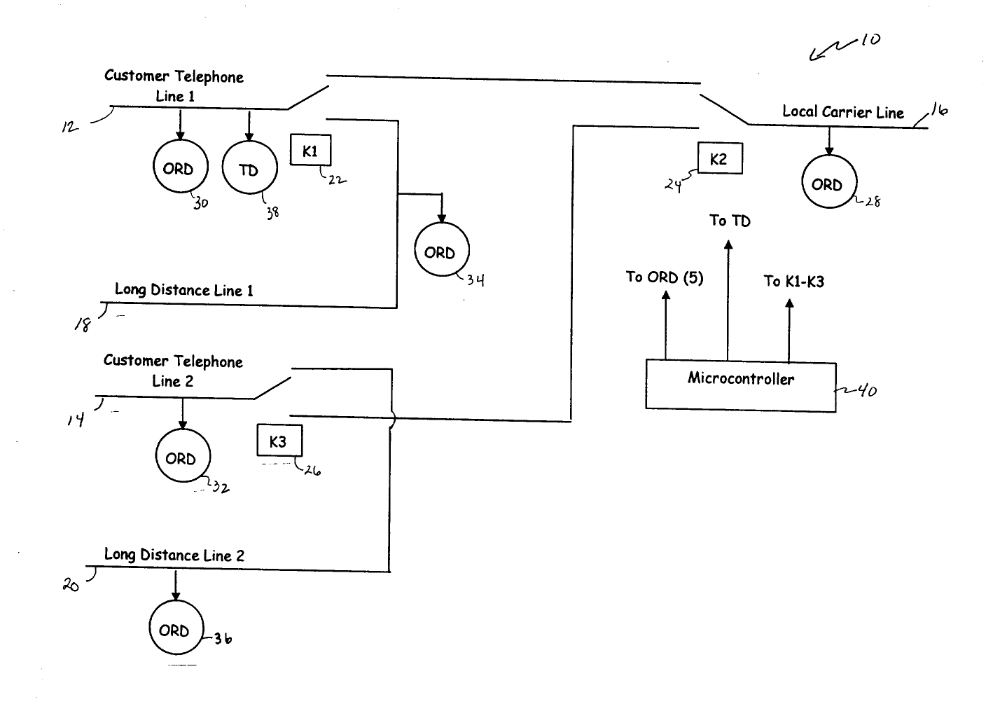

### TECHNICAL FIELD

The invention herein resides in the art of telephony. More particularly, the invention relates to a system which allows for the automatic interconnection of a customer's telephone lines with predetermined service providers. Specifically, the invention relates to a telephonic carrier selection system in which a controller effects the interconnection of the customer's telephone line with one of various service providers.

### BACKGROUND ART

Presently, alternate sources for long distance service are being made available to residences and businesses, creating new requirements to effect the selection of these services at the customer premises. Presently, the provider of local telephone service is required to provide local directory assistance, emergency access (e.g. 911), incoming calling (ringing), and the like. At the same time, long distance calling (1+ and 011+) is provided by any number of services including preferred carrier, 1010XXX access, 800/888/877 access, and the like. The telephone user must, accordingly, tell his/her telephone company whom they desire to provide their long distance service for the 1+ and 011+ calls or they must use one of the other access methods just mentioned.

Residential and business telephone service is becoming available from alternate sources that can be accessed by means not connected to or associated with the conventional wire/pair based telephone systems of today. In its earliest form, alternate long distance services are available. Ultimately, all services, including local, will be available from these sources.

The new service providers can be data based (packetized) voice or Voice Over Internet Protocol, wireless or other means. In the end, consumers in the home or business need a method to maintain simple use of their telephones to access these alternate services. These services are accessible in the home or business from telephone jacks on cable modems or cellular/PCS/wireless network access units. Presently, there is no simple means to provide simple, familiar user access to these services from standard telephones and telephone systems. There is such a need in the art.

Presently, access to long distance and enhanced telephone services from residential and small business telephones and telephone systems is made using standard telephone connections to the Local Exchange Carrier (LEC) or Competitive Local Exchange Carrier (CLEC). As such, there is equivalently one pair of wires for each telephone circuit at the customer's premises. These pairs may be made available to high capacity circuits such as T1 or ISDN, but the end result is the same—one pair of wires per telephone circuit.

When an alternate provider makes its service available to the customer, a means is needed to allow the customer to access the alternate service using their regular telephone and normal, familiar dialing patterns. This requires special switching at the customer premises based on the current condition of the local telephone and telephone lines. For example, when making a local call, the telephone should access the Local Carrier's telephone system. When making a long distance call, the telephone should access the Long Distance Carrier's telephone system. Means need to be provided for handling situations where the customer's telephone is “off-hook” (being used on one provider's system) and a call is being received on the other provider's system. Versions of the invention presented herein can handle such telephone installations for between one and eight telephone lines. Multiple such systems can be used where more lines are required or an expanded version of the present embodiment can be employed using the same principles described herein.

### DISCLOSURE OF THE INVENTION

In light of the foregoing, it is an aspect of the invention to provide a telephonic carrier selection system which allows for ease of use of multiple telephone service providers.

Another aspect of the invention is the provision of a telephonic carrier selection system which allows for automatic interconnection to an appropriate service provider as indicated by the digits dialed by a user.

Yet a further aspect of the invention is the provision of a telephonic carrier selection system in which a user can easily override an automatic selection feature of the system and specifically select a provider for the service of a particular call.

Still a further aspect of the invention is the provision of a telephonic carrier selection system which allows for the use of standard connectors to interface between a customer's telephone system and the lines of carrier providers.

Yet a further aspect of the invention is the provision of a telephonic carrier selection system which is easily employed with multiple customer lines and among various service providers.

The foregoing and other aspects of the invention which will become apparent as the detailed description proceeds are achieved by a telephonic carrier selection system for selecting between service providers, comprising: a first customer telephone line; a local carrier line; a first long distance line; a first switch interposed among said first customer telephone line, first long distance line and local carrier line; and a controller connected to said first switch, said controller selectively interconnecting said first customer telephone line with one of said first long distance line and said local carrier line.

### DESCRIPTION OF THE DRAWING

For a complete understanding of the objects, technique and structure of the invention reference should be made to the following detailed description and accompanying drawing wherein a functional block diagram of the invention can be seen.

### BEST MODE FOR CARRYING OUT THE INVENTION

In its basic form, the telephone carrier selection system according to the invention has the following elements and capabilities for each carrier service to be accessed:

1. Two wire connection to the local carrier.

2. Two wire connection to the long distance/enhanced services provider.

3. Two wire connection to the customer telephone or telephone system (PBX).

4. Two wire connection to the customer's additional telephone line or answering machine.

5. A matrix of switching elements (typically relays) to select which carrier is to be used on a call-by-call basis.

6. Ability to decode Dual Tone Multi-Frequency (DTMF) tones generated by the customer telephone.

7. Ability to detect on-hook, off-hook and ringing conditions on each and all of the lines connected to the unit.

8. A controlling processor that monitors telephone activity at the customer's premises and switches the customer's telephones and optional answering machines to the proper carrier as required.

9. Standard RJ-11 connections, or other appropriate means for interface to the carrier's and telephones.

With reference now to the drawing, an appreciation can be obtained of a typical implementation of a telephonic carrier selection system made in accordance with the invention. The system, designated generally by the numeral 10, supports one line from a local carrier, two lines from a Long Distance Carrier, and a two-line telephone. Following an appreciation and understanding of the concept of the invention as presented with respect to this single embodiment, the expansion of the concept of the invention to more complex systems will be readily appreciated.

The basic structural elements of the system 10 include a first customer telephone line 12 and a second customer telephone line 14 adapted for selective interconnection between and among a local carrier line 16, a first long distance line 18 and a second long distance line 20. The selective interconnection is obtained by relays 22-26. As shown, the relay 22 (K1) is operative to selectively switch the first customer telephone line 12 between the local carrier line 16 and the first long distance line 18. In like manner, the relay 24 (K2) is operative to switch the local carrier line 16 between the first customer telephone line 12 and the second customer telephone line 14. Finally, the relay 26 (K3) is operative to switch the second customer telephone line 14 between the local carrier line 16 and the second long distance line 20.

Each of the lines 12-20 has an associated off-hook ring detector (ORD) 28-36. Those skilled in the art will appreciate that such an element monitors the condition of the telephone line as to whether the line is “on-hook,” “off-hook,” or ringing. An off-hook condition is indicated by the output of a logic 0, and on-hook condition by a logic 1, and ringing by alternating ones and zeros.

Finally, the first customer telephone line 12 has associated therewith a dual tone multi-frequency decoder or tone detector 38, generating output signals corresponding to the associated digits dialed by the telephone tied to the line 12.

A controller 14, such as a microprocessor or the like, interconnects with and receives data from the tone detector 38 and each of the off-hook/ring detectors 28-36 to determine the requests/needs of the customer employing the system 10 and to thereby control the relay 22-26, to which it is connected, to effect the necessary and desired line interconnections.

With continued reference to the drawing, it will be appreciated that the system 10 is connected to the various lines 12-20 using standard RJ11 or other suitable connectors as are well known and understood by those skilled in the art. Each of the lines 12-20 has an associated off-hook/ring detector 28-36 which serves to monitor the voltage on the associated line and communicate that line status to the controller 40. As presented above, when the associated line is “off-hook,” the controller 40 sees a logic 0; when “on-hook,” the controller 40 sees a logic 1; and when the line is ringing, the controller 40 sees alternating or pulsating ones and zeros corresponding to the frequency of the ringing voltage.

In the normal idle or powered-down condition, relays 22, 24, 26 are de-energized in the position shown in the drawing. Accordingly, the first customer telephone line 12 is connected to the local carrier line 16 while the second customer telephone line 14, which might simply be an answering machine, is connected to the second long distance line 20.

When a call is received from the Local Carrier, the first customer telephone line 12 receives the call due to the quiescent state of the switches 22-26. The controller detects the ringing action using the ORD 28 and causes the tone detector 38 to be ignored until the first customer telephone line 12 is answered (off-hook) and then returned to an on-hook condition, or when ringing ceases.

When the customer desires to make a call, the customer picks up the telephone line tied to the first customer telephone line 12. The ORD30 detects this status and passes a representative signal to the controller 40. When the first digit is dialed by the customer, the tone detector 38 senses the nature or value of that digit and passes a signal corresponding to the same to the controller 40. If the first digit is not a “1” or a “0,” no further action is taken and the tone detector 38 is ignored until the first customer telephone line 12 is returned to an on-hook condition. However, if the first digit dialed is a “1,” the controller 40 activates relays 22, 24, thereby “hanging up” or disconnecting the local carrier line 16. Further digits dialed are ignored by the tone detector 38 until the first customer telephone line 12 is returned to an on-hook condition. If the first digit dialed is a “0,” followed by any other digit than “1,” no further action is taken and all tones are ignored until the first custom telephone line 12 is returned to an on-hook condition. However, if the first digit dialed is a “0” followed by the dialing of the digit “1” (indicating an international call), the controller 40 actuates the relays 22, 24, thereby “hanging up” on the local carrier line 16. Further digits dialed are ignored by the tone detector 38 until the first customer telephone line 12 is returned to on-hook. This may be accomplished internally by the controller 40, or the controller 40 may simply disable, inhibit or mask the tone detector 38 during such time.

It will be appreciated that it is the responsibility of the Long Distance Carrier to handle the digits received from the customer's location. These digits may or may not include the leading “1” or “0” depending upon the interface used by the Long Distance Carrier.

If the first customer line 12 is busy on a long distance call using the first long distance line 18, and ringing is detected by the controller 40 using the ORD 28 on the local carrier line 16, the controller 40 determines if the second customer telephone line 14 is off-hook by monitoring the ORD 32. If the second customer telephone line 14 is not off-hook, relays 24, 26 are energized by the controller 40, thereby routing the local carrier 16 to the second customer telephone line 14. This condition remains until either the second customer telephone line 14 is answered and then returned to an on-hook condition, or until ringing stops on the local carrier line 16. The termination of ringing is determined by the absence of ringing for a predetermined period of time, such as five seconds.

If will, of course, be appreciated that a customer, using the second customer telephone line 14, may place a long distance call over the second long distance line 20, if available.

As part and parcel of the instant invention, special services accessed with the “*” key, such as caller ID block, call trace, etc. are supported. The instant invention will not switch to the long distance carrier when a “*” is detected by tone detector 38 as the first digit. If the caller desires to use the local carrier for a call that starts with 1, 0, or 01, the caller presses the “#” key first. The microcontroller 40 causes relay 24 to “hang up” on the local carrier to clear the “#” that has been sent, wait a short period of time, then reconnect line 12 to the local carrier, thus providing a new dial tone to the caller from the local carrier. From this point until the caller on line 12 hangs up, all initial digits will be sent to the local carrier, including 1, 0, or 01, irrespective of which line might otherwise have been automatically selected. This selection remains in effect until the first customer telephone line 12 is returned to an on-hook condition.

It will be appreciated that the controller 40 continually monitors the status of the lines 12-20 at all times. When the line status of an associated line returns to on-hook, the associated relays are returned to their respective idle statuses. Further, in the preferred embodiment of the invention, the controller 40 causes the default position of the relay switches 22-26 to be shown in the drawing, with lines 12 and 16 interconnected and lines 14 and 20 interconnected.

Thus it can be seen that the objects of the invention have been satisfied by the structure presented above. While in accordance with the patent statutes only the best known and preferred embodiment of the invention has been presented and described in detail, the invention is not limited thereto or thereby. Indeed, for multiple carrier line installations, the implementation described herein is expanded in a manner which would be obvious to anyone skilled in the art. Accordingly, for a true appreciation of the scope and breadth of the invention reference should be made to the following claims.

What is claimed is:

1. A telephonic carrier selection system for selecting between service providers, comprising:
a first customer telephone line;
a local carrier line;
a first long distance line;
a first switch interposed among said first customer telephone line, first long distance line and local carrier line; and
a controller connected to said first switch, said controller selectively interconnecting said first customer telephone line with one of said first long distance line and said local carrier line.

2. The telephone carrier selection system according to claim 1, further comprising a tone detector interconnected between said first customer telephone line and said controller, said controller effecting said interconnecting of said first customer telephone line with one of said first long distance line and said carrier line as a function of an output of said tone detector.

3. The telephone carrier selection system according to claim 2, further comprising:
a second customer telephone line;
a second long distance line; and
a second switch connected to said controller and interposed among said second customer telephone line, first long distance line, and local carrier line, said controller effecting interconnection of said second customer telephone line with one of said second long distance line and said local carrier line.

4. The telephone carrier selection system according to claim 3, further comprising a third switch interposed among said local carrier line and said first and second switches, said third switch being connected to and controlled by said controller, said controller selectively interconnecting said local carrier line with one of said first and second switches.

5. The telephone carrier selection system according to claim 4, wherein an off hook/ring detector is interposed between each of said local carrier line, first and second customer telephone lines and first and second long distance lines and said controller.

6. The telephone carrier selection system according to claim 5, wherein said controller, through said first switch, connects said first customer telephone line with said first long distance line when the first digits dialed on said first customer telephone line are from the group of 1 and 01.

7. The telephone carrier selection system according to claim 6, wherein said controller, through said first switch, connects said first customer telephone line with said first long distance line when the first digit dialed on said first customer telephone line is from the group of * and # and said controller, through said first switch, maintains said first customer line in interconnection with said local carrier line when the first digit dialed on said first customer telephone line is the other digit of the group * and #.
